(19) United States
(12) Patent Application Publication
(10) Pub. No.: US 2024/0422873 A1
(43) Pub. Date: Dec. 19, 2024

(54) SYSTEM AND METHOD FOR CONTROLLING MULTICOLOR LED LIGHT SYSTEM

(71) Applicant: Holiday Designs, LLC, Bannockburn, IL (US)

(72) Inventor: Chunwa Nguy, Cornelius, NC (US)

(21) Appl. No.: 18/677,043

(22) Filed: May 29, 2024

Related U.S. Application Data
(60) Provisional application No. 63/508,412, filed on Jun. 15, 2023.

(51) Int. Cl. H05B 45/20; H05B 45/10; H05B 47/175

(52) U.S. Cl. CPC H05B 45/20; H05B 45/10; H05B 47/196

(57) ABSTRACT

Methods, computing devices, and non-transitory computer-readable storage mediums are provided for controlling a multicolor light emitting diode (LED) light system. The method can be applied to a control unit that can obtain an input command. The control unit can also determine at least one color to display on the LED light system based on the input command. The LED light system can include multiple LEDs connected in series. The control unit can further determine a brightness level to display on the LED light system based on the input command. The control unit can also determine a light pattern to display on the LED light system based on the input command. The control unit can further output a power level to power the LED light system. The control unit can also output control data to display the at least one color and the light pattern on the LED light system. The LED light system can be, for example, an LED light rope.

### CROSS-REFERENCE TO RELATED APPLICATION DATA

This application claims the benefit of and priority to Provisional U.S. Patent Application Ser. No. 63/508,412, filed Jun. 15, 2023, the disclosure of which is incorporated herein in its entirety.

### BACKGROUND

This disclosure is related to a system and method for controlling a multicolor light emitting diode (LED) light system.

LED lights have evolved with advancements in the technology allowing for improved efficiency, brightness, and color quality. They have also become more affordable and accessible. LED lights have been incorporated into LED light strings that consist of a series of small, energy efficient LED lights connected together to create a string, chain, or rope. However, because of cost, LED light strings have been limited in their color output, as, well as the effects or patterns available for illuminating such light systems.

Accordingly, it is desirable to provide a multicolor LED light system and method for controlling LED light systems.

### SUMMARY

A system and method for controlling multicolor Light Emitting Diode (LED) light systems are provided according to various embodiments.

In one aspect, a method for controlling a multicolor LED light system is provided. The method may be applied to a computing unit. The computing unit may obtain an input command. The input command may include a light output selection. The computing unit may determine at least one color to display on an LED light system based on the input command. The LED light system may include multiple LEDs connected in series. The computing unit may determine a brightness level to display on the LED light system based on the input command. The computing unit may determine a light pattern to display on the LED light system based on the input command. The computing unit may output a power level to power a light system. The computing unit may output control data to display the at least one color and the light pattern on the LED light system. The LED light system can be an LED light rope.

In a second aspect, a computing device for controlling a multicolor LED light system is provided. The computing device may include one or more processors, a non-transitory computer-readable memory storing instructions executable by the one or more processors. The one or more processors may be configured to obtain an input command. The input command may include a light output selection. The one or more processors may further be configured to determine at least one color to display on an LED light system based on the input command. The LED light may include multiple LEDs connected in series.

The one or more processors may further be configured to determine a brightness level to display on the LED light system based on the input command. The one or more processors may further be configured to determining a light pattern to display on the LED light system based on the input command. The one or more processors may further be configured to output a power level to power a light system. The one or more processors may further be configured to output control data to display the at least one color and the light pattern on the LED light system. The LED light system can be an LED light rope.

In a third aspect, a non-transitory computer-readable storage medium having instructions stored therein is provided. When the instructions are executed by one or more processors of a computing device, the instructions may cause the computing device to perform obtaining an input command. The input command may include a light output selection. The instructions may further cause the computing device to perform determining at least one color to display on an LED light system based on the input command. The LED light system may include multiple LEDs connected in series.

The instructions may further cause the computing device to perform determining a brightness level to display on the LED light system based on the input command. The instructions may further cause the computing device to perform determining a light pattern to display on the LED light system based on the input command. The instructions may further cause the computing device to perform outputting a power level to power a light system. The instructions may further cause the computing device to perform outputting control data to display the at least one color and the light pattern on the LED light system. The LED light system can be an LED light rope.

The foregoing general description and the following detailed description are examples only and are not restrictive of the present disclosure.

### DESCRIPTION OF THE DRAWINGS

The benefits and advantages of the present embodiments will become more readily apparent to those of ordinary skill in the relevant art after reviewing the following detailed description and accompanying drawings, wherein:

FIG. 1 is a front view of a multicolor LED light system illustrated as a rope light, according to an embodiment;

FIG. 2 is a circuit diagram of the multicolor LED rope light of FIG. 1;

FIG. 3A is a top layer circuit diagram of a control unit, according to an embodiment;

FIG. 3B is a bottom layer circuit diagram of the control unit of FIG. 3A;

FIG. 4 is a top view of a controller, according to an embodiment;

FIG. 5 is a top view of a controller, according to an embodiment;

FIG. 6A is a top layer circuit diagram of a controller, according to an embodiment;

FIG. 6B is a bottom layer circuit diagram of the controller of FIG. 3A;

FIG. 7 is a method for controlling a multicolor LED light system, according to an example of the present disclosure;

FIG. 8 is a method for controlling a multicolor LED light system, according to an example of the present disclosure;

FIG. 9 is a diagram illustrating a computing environment coupled with a user interface, according to an example of the present disclosure;

FIG. 10 is a front view of a multicolor LED light system illustrated as a rope light, according to an embodiment;

FIG. 11 is a circuit diagram of the multicolor LED rope light of FIG. 10;

FIG. 12 is a circuit diagram of a multicolor LED light system, according to an embodiment;

FIG. 13A is a top layer circuit diagram of a control unit, according to an embodiment; and

FIG. 13B is a bottom layer circuit diagram of the control unit of FIG. 13A.

### DETAILED DESCRIPTION

While the present disclosure is susceptible of embodiment in various forms, there is shown in the drawings and will hereinafter be described presently preferred embodiments with the understanding that the present disclosure is to be considered an exemplification and is not intended to limit the disclosure to the specific embodiments illustrated. The words “a” or “an” are to be taken to include both the singular and the plural. Conversely, any reference to plural items shall, where appropriate, include the singular.

The present disclosure provides a system and method for controlling a multicolor Light Emitting Diode (LED light system. LEDs can be arranged in series to form a rope, string, tape, and the like of LEDs that can be powered to output light. The LEDs can include multicolor LEDs that can output a variety of colors. The LED lights can further be controlled to output certain patterns or light levels. These multicolor LED light system can be used to decorate indoor and outdoor spaces for not only lighting but celebrating holidays, festivals and the like.

For example, the multicolor LED light system can be installed outside a house to output red and green colors for the Christmas holiday. Similarly, the multicolor LED light system can be controlled to output a twinkle pattern with Christmas holiday lights to accomplish a Christmas holiday feel to the exterior of a home. For example, the Christmas holiday lights can include a steady red, steady green, steady orange, steady purple, steady blue, steady white, steady warm white, and steady red, green, orange, purple, blue, white, and warm white combination color light output.

In another example, the multicolor LED light system can output orange, purple, green, and orange colors for the Halloween holiday. For example, the Halloween holiday can include a steady orange, steady purple, steady green, and steady orange, purple and green combination color light output.

In yet another example, the multicolor LED light system can output blue, red, white, and blue colors for the National Day holiday (Independence Day). For example, the National Day holiday can include a steady Blue, steady Red, steady White, and steady blue/red/white combination color light output.

In an embodiment, the multicolor LED light system can be a high-voltage or low-voltage point-controlled RGB patch lamp belt that is rich in color. In another embodiment, the multicolor LED light system can be a high-voltage or low-voltage point-controlled RGB surface-mounted device (SMD) strip light. The multicolor LED light system can output various colors through a control unit. This may add more color to a user's increasingly beautiful life. The multicolor LED light system can include predefined themes or festivals. For example, the festivals may be National day, Halloween, and Christmas.

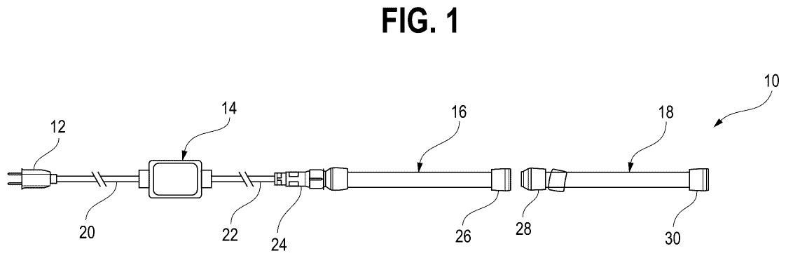

Referring now to the figures, FIG. 1 show a multicolor LED light system illustrated as a rope light 10. According to the example embodiment shown in FIG. 1, the multicolor LED rope light 10 can include a power connector/plug 12, a control unit 14, a first LED light strip 16, a second LED light strip 18, a power cable 20, an LED driver 22, a power connector 24, a first connector end 26, a second connector end 28, and third connector end 30. The plug 12 can have two or three metal prongs that can connect to a power source (for example, a wall socket). The power cable 20 can supply power from the plug 12 to the control unit 14. The control unit 14 can supply power and control data to the multicolor LED rope light 10 through the LED driver 22. The power connector 24 can connect to the LED driver 22.

The first LED light strip 16 can have a fixed connection to the power connector 24. The first LED light strip 16 can connect to additional LED light strips using the first connector end 26. The second LED light strip 18 can connect to the multicolor LED rope light 10 using the second connector end 28 and its first connector end 26. Similarly, the third connector end 30 can further connect to other LED light strips. In an embodiment, the multicolor LED rope light 10 can be a high-voltage LED rope light. IN an embodiment, the location of the control unit 14 and the LED driver 22 can be reversed, such that the LED driver is 22 is upstream of the control unit 14.

In an embodiment, the connector ends 26, 28, 30 can be clip-on connectors, screw-on connectors, snap-on connectors, or plug-in connectors. In an embodiment, the power connector 24 can have a non-fixed connection to the first LED light strip 16. The power connector 24 can have a connector end that can connect to a second connector end on the first LED light strip 16. In an embodiment, the multicolor LED rope light 10 can include one, two, three, four or more LED light strips. In an embodiment, the multicolor LED rope light 10 can illuminate a white color light when powered on.

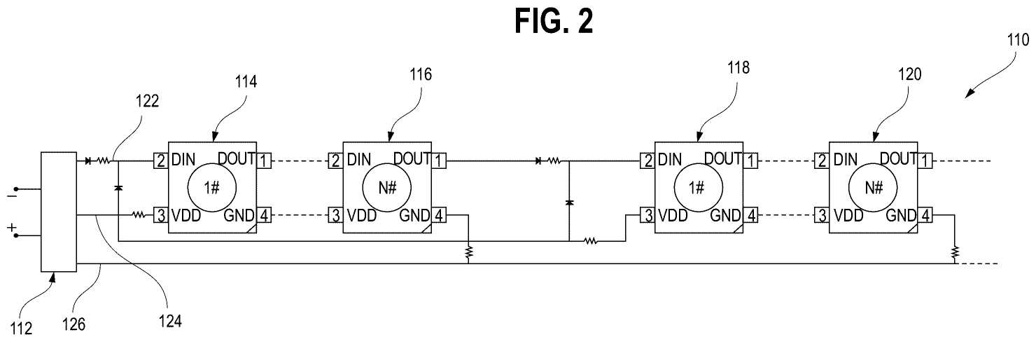

FIG. 2 shows a circuit diagram of a multicolor LED light system illustrated as a rope light 110. According to the example embodiment shown in FIG. 2, the multicolor LED rope light 110 can include a control unit 112, a first LED unit 114, a second LED unit 116, a third LED unit 118, a fourth LED unit 120, a data connector 122, a V+ connector 124, and a V-connector 126. The control unit 112 can provide power and control data to the LED units 114, 116, 118, 120 through the V+ connector 124, the V-connector 126, and the data connector 122. In an embodiment, the first LED unit 114 and second LED unit 116 can be part of the first light strip 16. The third LED unit 118 and fourth LED unit 120 can be part of the second LED light strip 18. It will be appreciated by those skilled in the art that any number of LED units 114, 116, 118, 120 and light strips 16, 18 can be employed.

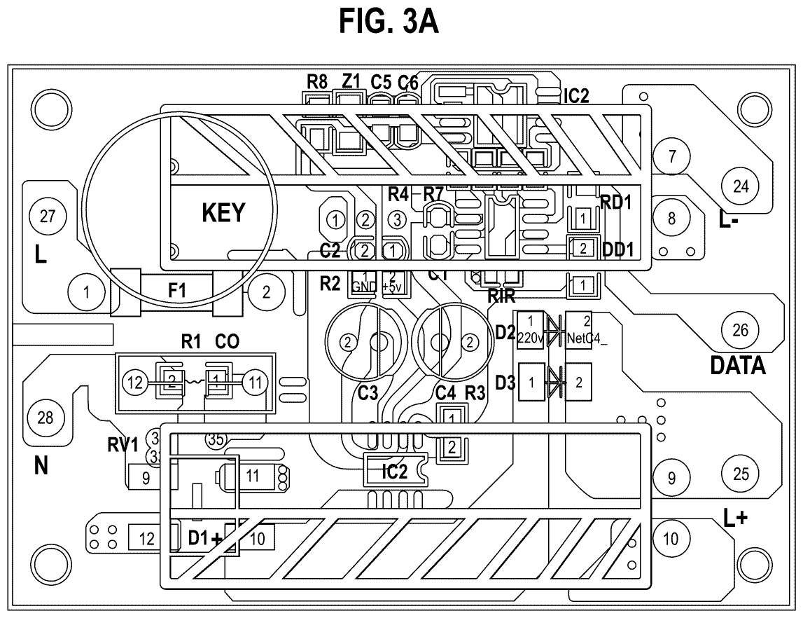

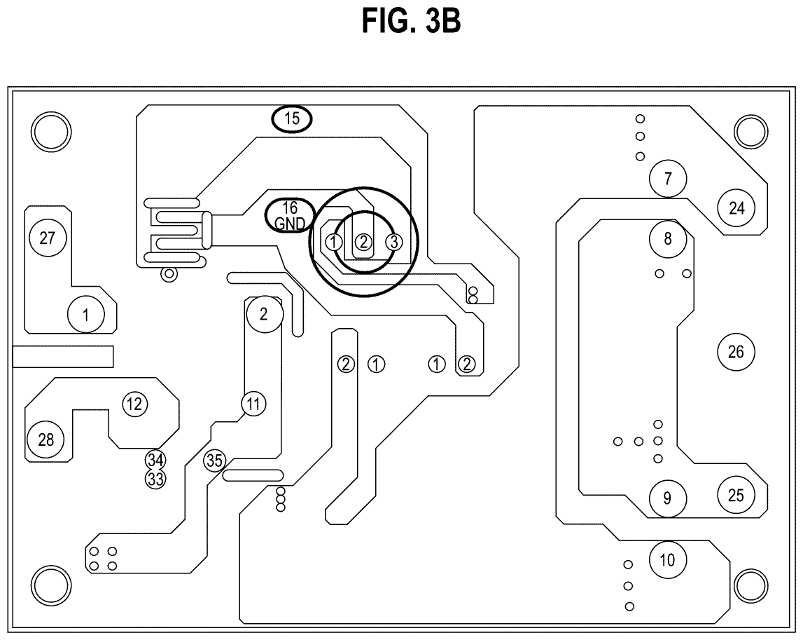

In an embodiment, the control unit 14, 112, can include an electrical circuit as shown in FIGS. 3A and 3B. FIG. 3A shows a circuit diagram of the top layer of a control unit. FIG. 3B shows a circuit diagram of the bottom layer of the control unit. In an embodiment, the control unit 14, 112 can be part of a high-voltage LED rope light.

In an embodiment, the control unit 14, 112, 414 can receive commands from a controller (controller 210) using radio frequency (RF) technology. For example, the RF signal can include a 38KHZ carrier command key code sent by the infrared remote control 210. When the key code sent by the infrared remote control 210 is consistent with the key code of the controller, the controller can send the corresponding data to control the multicolor LED rope light 10 to output light according to the received commands. Other types of wireless communications, including infrared (IR), Bluetooth, WI-FI, Zigbee, Z-Wave, LoRaWAN, Near Field Communication (NFC), and Ultra-Wideband (UWB) technology are contemplated.

In an embodiment, the control unit 14, 112, 414 can receive user input commands from a controller 210.

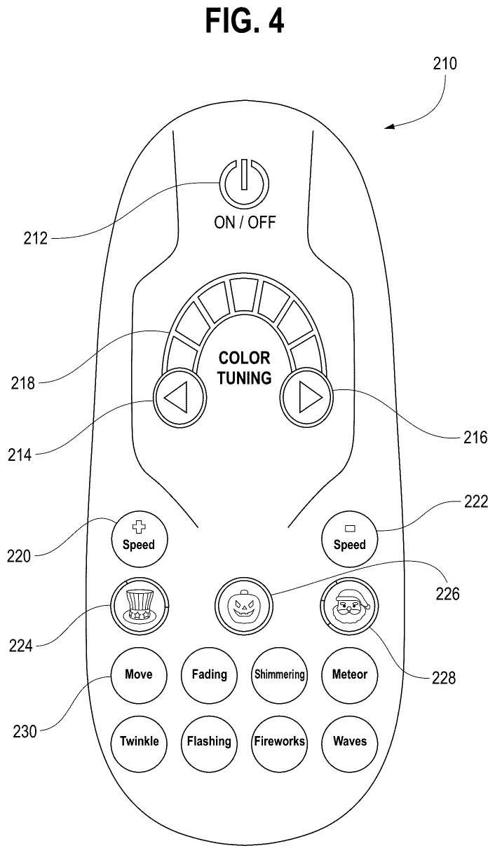

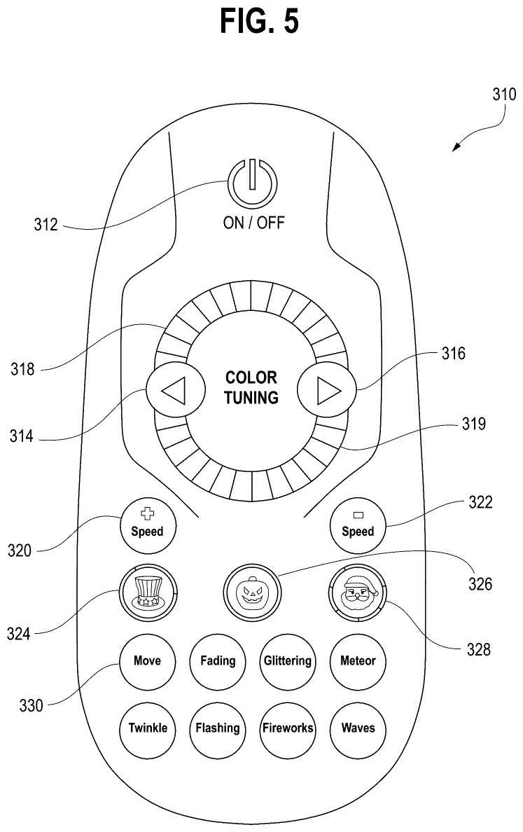

FIGS. 4 and 5 show a controller 210, 310 according to several embodiments. The illustrated controller 210, 310 can include a power button 212, 312, a first color tuning button 214, 314, a second color tuning button 216, 316, a first color indicator 218, 318, a plus speed button 220, 320, a reduce speed button 222, 322, a first special light scheme button 224, 324, a second special light scheme 226, 326, a third special light scheme button 228, 328, and at least one sequence button 230, 330. The power button 212 can turn on and off the LED light output of the multicolor LED rope light 10. The color tuning buttons 214, 314, 216, 316 can be used to change between a set of colors being output by the multicolor LED light system 10.

For example, the user can switch between red, yellow, green, cyan, blue, purple, and white. The first color indicator 218, 318 can indicate the color sequence for when a user is switching through color outputs using the first color tuning button 214, 314 and the second color tuning button 216, 316. In an embodiment, the first color tuning button 214, 314 can move counterclockwise through the colors on the first color indicator 218, 318 and counterclockwise using the second color tuning button 216, 316.

In another embodiment, the first color indicator 218, 318 can be a plurality of color buttons 218 that can be used to output a specific color by the multicolor LED light system 10. For example, the first color indicator 218, 318 can be a blue button that will cause the multicolor LED light system 10 to output a blue color. In another example, the first color indicator 218, 318 can include multiple buttons with each button causing the multicolor LED light system 10 to illuminate the specific color when pressed.

In an embodiment, the controller 210, 310 can include a red light on each of the first special light scheme button 224, 324, the second special light scheme 226, 326, the third special light scheme button 228, 328 to guide the current selection. The red light can be turned on when one of the buttons is selected and can stay on for predetermined amount of time. For example, the red light can stay on for three minutes.

FIG. 4 shows a front view of the controller 210. According to example embodiment shown in FIG. 4, the first color indicator 218 can indicate a color sequence including red, yellow, green, cyan, blue, purple, and white.

FIG. 5 shows a front view of the controller 310. According to example embodiment shown in FIG. 5, the controller 310 can include a second color indicator 319. The first color indicator 318 can indicate a color sequence including various shades of red, yellow, green, cyan, and blue. The second color indicator 319 can indicate a color sequence including various shades of pink, purple, and blue.

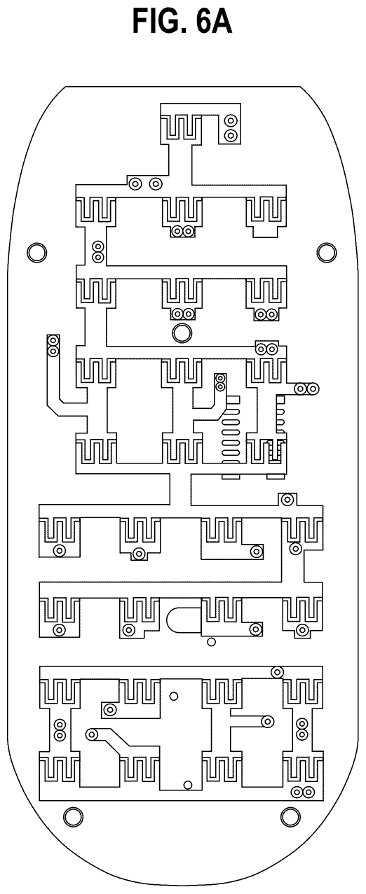

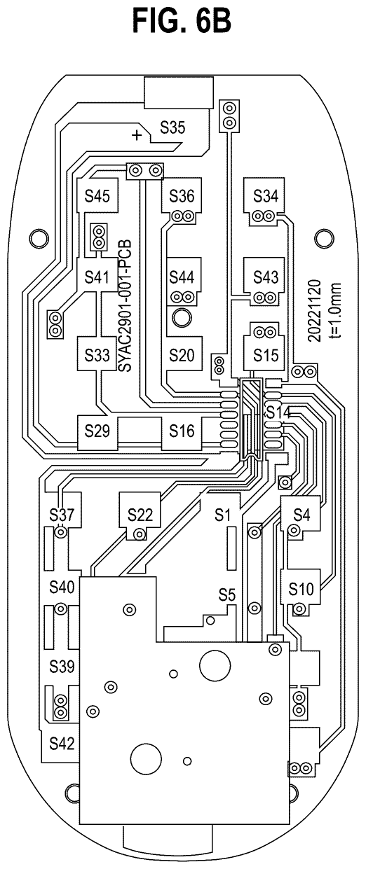

FIG. 6A shows a top circuit layer of the controller 210, 310. FIG. 6B shows a bottom circuit layer of the controller 210, 310.

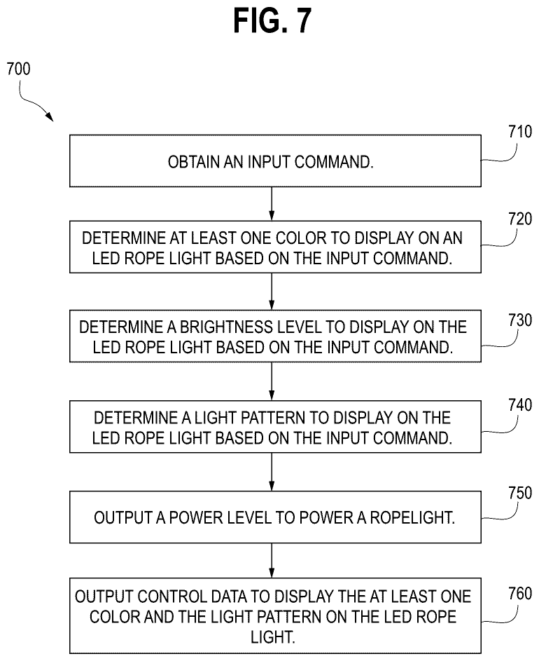

FIG. 7 shows a method 700 for controlling an LED light rope. The method may be applied to a control unit, computing device, mobile device, personal computer, or server.

In step 710, the control unit may obtain an input command, wherein the input command comprises a light output selection.

In step 720, the control unit may determine at least one color to display on an LED light system based on the input command, wherein the LED light system comprises multiple LEDs connected in series.

In step 730, the control unit may determine a brightness level to display on the LED light system based on the input command.

In step 740, the control unit may determine a light pattern to display on the LED light system based on the input command.

In step 750, the control unit may output a power level to power the light system.

In step 760, the control unit may output control data to display the at least one color and the light pattern on the LED light system.

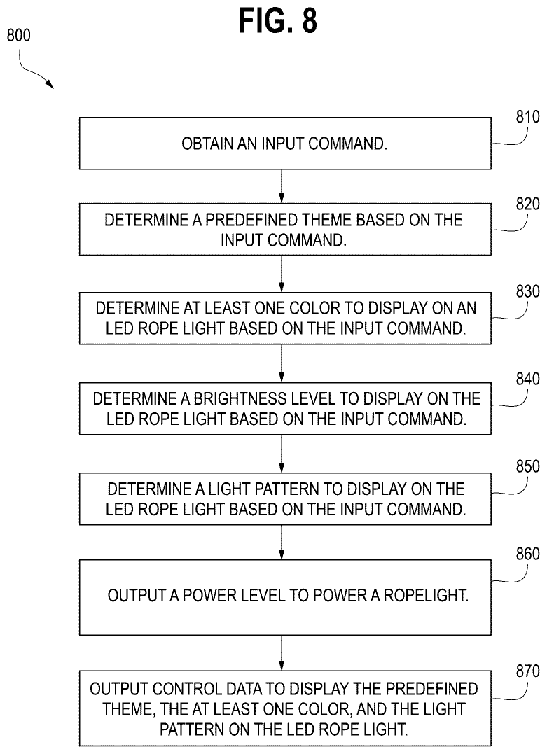

FIG. 8 shows a method 800 for controlling an LED light system. The method may be applied to a control unit, computing device, mobile device, personal computer, or server.

In step 810, the control unit may obtain an input command. The input command may include a light output selection.

In step 820, the control unit may determine a predefined theme based on the input command. The predefined theme may include a predefined color, predefined brightness level, and predefined light pattern to display on the LED light system. For example, the predefined theme can be a festival with corresponding representative colors. Each color can correspond to eight dynamic effect changes. For example, the eight dynamic effect changes can include a move pattern or effect, a fading pattern or effect, a shimmering pattern or effect, a meteor pattern or effect, a twinkle pattern or effect, a flashing pattern or effect, a fireworks pattern or effect, and a waves pattern or effect, as well as other patterns or effects.

In an embodiment, the move dynamic effect can move the corresponding color output when selected. The fading dynamic effect can gradient the corresponding output color. For example, outputting an output that gradually and smoothly varies the brightness, color, or intensity of the light output. The shimmering dynamic effect can jump to the corresponding output color. For example, outputting a sparkling or shimmering visual effect by rapidly and intermittently varying the brightness, color, or intensity of the light output in a random or semi-random pattern. The meteor dynamic effect can output a meteor effect corresponding to the selected output color. For example, outputting a rapidly and intermittently altering the brightness, color, or intensity of the light output in a linear or cascading pattern. The twinkle dynamic effect can flash the corresponding output color. For example, outputting a twinkling or sparkling visual effect by rapidly and intermittently altering the brightness, color, or intensity of the light output.

The flashing dynamic effect can strobe the corresponding output color. For example, causing a light output to repeatedly switch on and off at a certain frequency, creating a flashing or strobing visual effect. The fireworks dynamic effect can flash the corresponding output color. For example, outputting an output that mimics the visual effects of fireworks by rapidly changing the brightness, color, and intensity of the light output. The waves dynamic effect can output a wave change of the corresponding output color. For example, outputting an output that simulates the visual effect of waves by gradually and smoothly varying the brightness, color, or intensity of the light output.

In an embodiment, the predefined theme or festival can include a National Day theme. The National Day theme can include a red, white, and blue, and blue color and red-white color combination. These four colors can correspond to 32 dynamic change effects when paired with the eight dynamic effect changes selected using the at least one sequence button 230, 330.

In an embodiment, the predefined theme or festival can include a Halloween theme. The Halloween theme can include an orange, purple, green, and orange color, and purple-green combination. These four colors can correspond to 32 dynamic change effects when paired with the eight dynamic effect changes selected using the at least one sequence button 230, 330.

In an embodiment, the predefined theme or festival can include a Christmas theme. The Christmas theme can include a red, green, orange, purple, blue, white, warm white, and red and green-orange-purple-blue-white warm-white combination. These eight colors can correspond to 64 dynamic change effects when paired with the eight dynamic effect changes selected using the at least one sequence button 230, 330.

In step 830, the control unit may determine at least one color to display on an LED light system based on the input command, wherein the LED light system comprises multiple LEDs connected in series.

In step 840, the control unit may determine a brightness level to display on the LED light system based on the input command.

In step 850, the control unit may determine a light pattern to display on the LED light system based on the input command.

In step 860, the control unit may output a power level to power the LED light system.

In step 870, the control unit may output control data to display the at least one color and the light pattern on the LED light system.

In an embodiment, the control unit can output 28 colors with eight dynamic effect variations including move, fade, shimmer, meteor, twinkle, flashing, fireworks, and waves, as well as other dynamic effects.

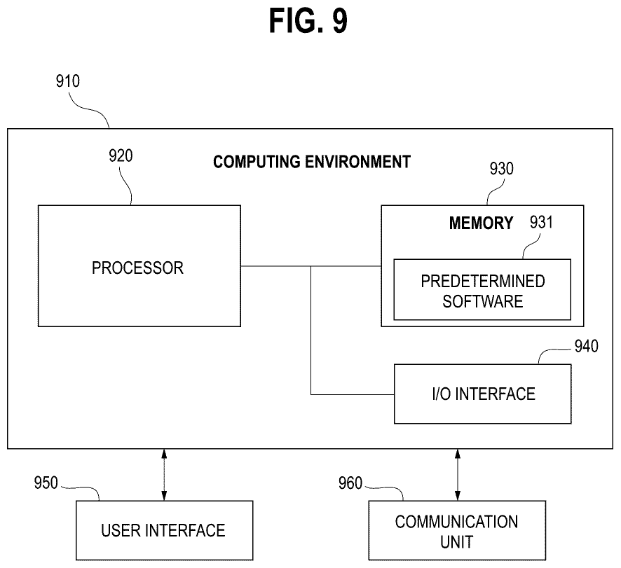

FIG. 9 shows a computing system 900. According to example embodiments shown schematically in FIG. 9, the computing system 900 can include a computing environment 910 coupled to a user interface 950 and a communication unit 960. The computing environment 910 can include a processor 920, a memory 930, and an I/O (input/output) interface 940. The computing environment 910 can be coupled to the user interface 950 and communication unit 960 through the I/O interface 940.

The processor 920 can typically control the overall operations of the computing environment 910, such as the operations associated with data acquisition, data processing, and data communications. The processor 920 can include one or more processors to execute instructions to perform all or some of the steps in the above-described methods. Moreover, the processor 920 can include one or more modules that facilitate the interaction between the processor 920 and other components. The processor may be or include a central processing unit (CPU), a microprocessor, a single chip machine, a graphical processing unit (GPU) or the like.

The memory 930 can store various types of data to support the operation of the computing environment 910. Memory 930 can include predetermined software 931. Examples of such data comprise instructions for any applications or methods operated on the computing environment 910, data, user input commands, etc. The memory 930 may be implemented by using any type of volatile or non-volatile memory devices, or a combination thereof, such as a static random-access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The I/O interface 940 can provide an interface between the processor 920 and peripheral interface modules, such as a RF circuitry, external port, proximity sensor, audio and speaker circuitry, video and camera circuitry, microphone, accelerometer, display controller, optical sensor controller, intensity sensor controller, other input controllers, keyboard, a click wheel, buttons, and the like. The buttons may include but are not limited to, a home button, a power button, and volume buttons.

The user interface 950 can include technologies for communicating with the user.

Communication unit 960 provides communication between the processing unit, an external device, mobile device, and a webserver (or cloud). The communication can be done through, for example, WIFI or BLUETOOTH hardware and protocols. The communication unit 960 can be within the computing environment or connected to it.

In some embodiments, there is also provided a non-transitory computer-readable storage medium comprising a plurality of programs, such as comprised in the memory 930, executable by the processor 920 in the computing environment 910, for performing the above-described methods. For example, the non-transitory computer-readable storage medium may be a ROM, a RAM, or the like.

The non-transitory computer-readable storage medium has stored therein a plurality of programs for execution by a computing device having one or more processors, where the plurality of programs when executed by the one or more processors, cause the computing device to perform the above-described method for motion prediction.

In some embodiments, the computing environment 910 may be implemented with one or more application-specific integrated circuits (ASICs), digital signal processors (DSPs), digital signal processing devices (DSPDs), programmable logic devices (PLDs), field-programmable gate arrays (FPGAs), graphical processing units (GPUs), controllers, micro-controllers, microprocessors, or other electronic components, for performing the above methods.

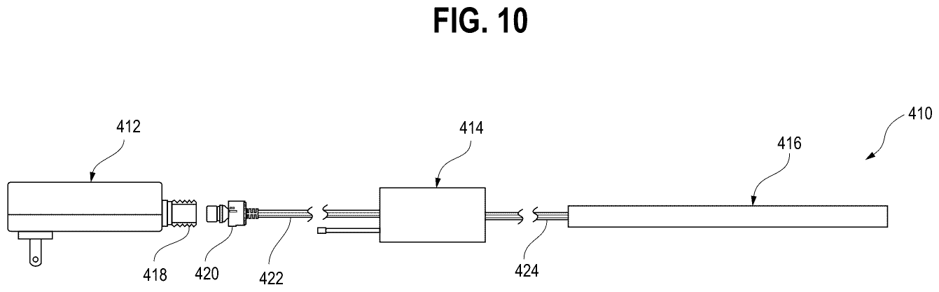

FIG. 10 show a multicolor LED light system illustrated as a rope light 410. According to the example embodiment shown in FIG. 10, the multicolor LED light system 410 can include a plug or electrical connector 412, a control unit 414, an LED light strip 416, a first connector 418, a second connector end 420, a first power cable 422, and a second power cable 424. The plug 412 can have two or three metal prongs that can connect to a power source (for example, a wall socket). In an embodiment, the plug 412 can supply 12V at 2.5 A power to power a strip of 216 LED lights. In another embodiment, the plug 412 can supply 12V at 5A to power a strip of 432 LED lights. The first power cable 422 can supply power from the plug 412 to the control unit 414. The control unit 414 can supply power and control data to the LED light strip 416.

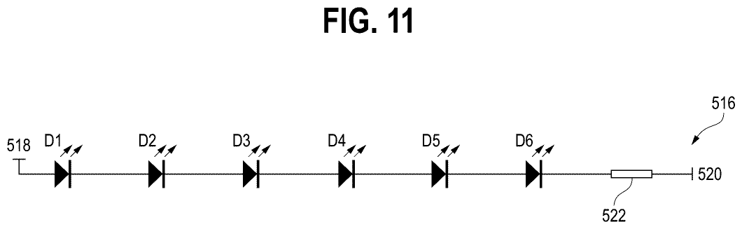

FIG. 11 shows a circuit diagram of an LED light strip 516. According to example embodiments shown in FIG. 11, the LED light strip 516 can include LEDs D1, D2, D3, D4, D5, D6, positive supply voltage 518, negative supply voltage 522, and resistor 522. The voltages 518, 520 can be 12V or 24V. The resistor 522 can be a resistor with an appropriate power rating such as a ¼ watt power rating.

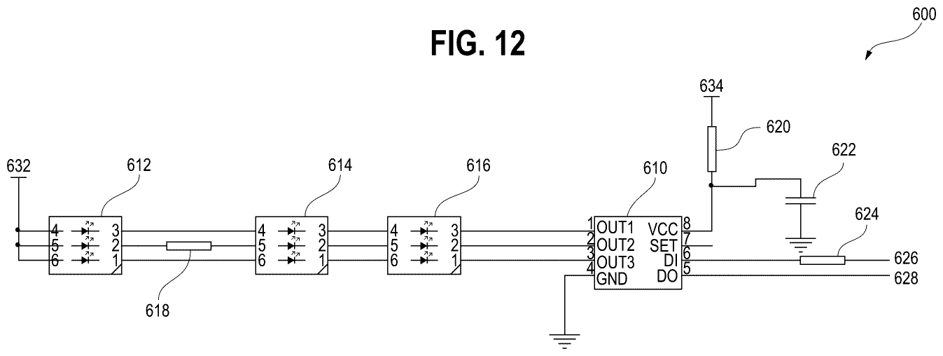

FIG. 12 shows a circuit diagram of a multicolor LED rope light 600, according to an embodiment. According to the example embodiment shown in FIG. 12, the multicolor LED light system 600 can include a microchip 610, a first, second, and third surface mount device (SMD) LED chip 612, 614, 616, a resistor 618, a variable resistor 620, a capacitor 622, an RD1 resistor 624, a data input 626, and a data output 628, and supply voltage 632, 634. The microchip 610 can be used to drive the SMD LED chips 612, 614, 616. The SMD LED chips 612, 614, 616 can be, for example, a 5050RGB-L1 chip that can output multiple colors. The supply voltage 632, 634 can be 12V or 24V.

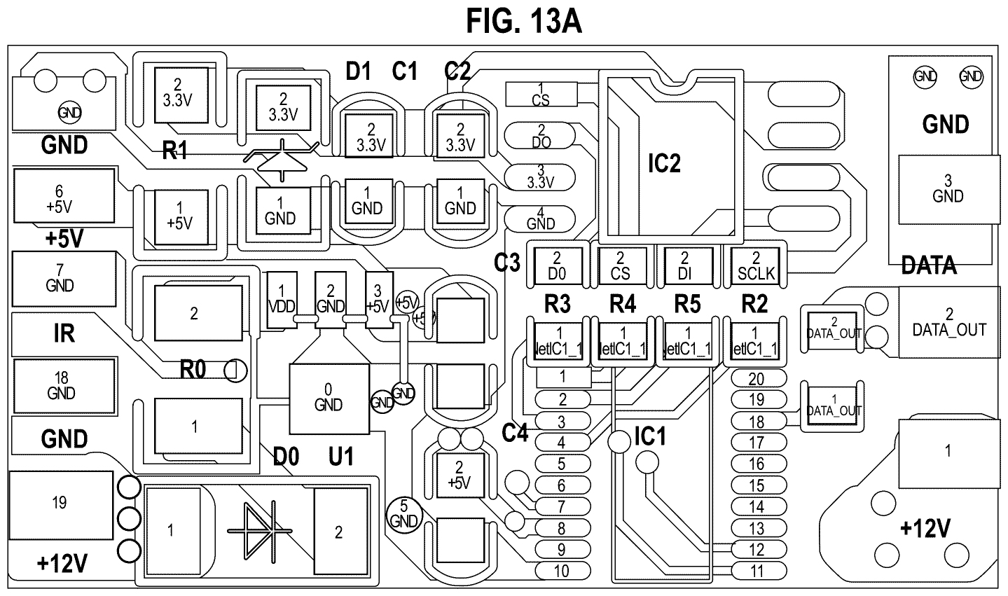

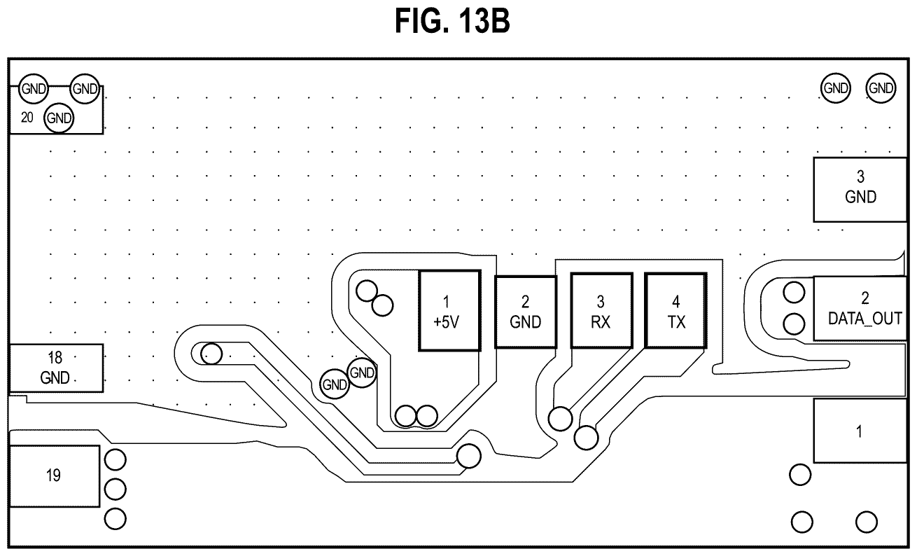

In an embodiment, the control unit 414, can include an electrical circuit as shown in FIGS. 13A and 13B. FIG. 13A shows a circuit diagram of the top layer of a control unit. FIG. 13B shows a circuit diagram of the bottom layer of the control unit. In an embodiment, the control unit 414 can be part of a low-voltage LED light system, such as a light rope or string.

From the foregoing it will be observed that numerous modifications and variations can be effectuated without departing from the true spirit and scope of the novel concepts of the present disclosure. It is to be understood that no limitation with respect to the specific embodiments illustrated is intended or should be inferred. The disclosure is intended to cover by the appended claims all such modifications as fall within the scope of the claims.

What is claimed is:

1. A method for controlling a multicolor light emitting diode (LED) light system comprising:
obtaining an input command, wherein the input command comprises a light output selection;
determining at least one color to display on an LED light system based on the input command, wherein the LED rope light comprises multiple LEDs connected in series;
determining a brightness level to display on the LED light system based on the input command;
determining a light pattern to display on the LED light system based on the input command;
outputting a power level to power the light system; and
outputting control data to display the at least one color and the light pattern on the LED light system.

2. The method of claim 1, further comprising:
determining a predefined theme based on the input command, wherein the predefined theme comprises a predefined color, predefined brightness level, and predefined light pattern to display on the LED light system; and
outputting the control data to display the predefined theme.

3. The method of claim 2, wherein the predefined theme comprises a Christmas holiday theme, wherein the Christmas holiday theme comprises a red, green, orange, purple, blue, white, warm white, and red-green-orange-purple-blue-white warm-white combination color, and light pattern output.

4. The method of claim 2, wherein the predefined theme comprises a Halloween holiday theme, wherein the Halloween holiday theme comprises an orange, purple, green, and orange-purple-green combination color, and light pattern output.

5. The method of claim 2, wherein the predefined theme comprises a National Day holiday theme, wherein the National Day holiday theme comprises a blue, red, white, and blue-red-white combination color and light pattern output.

6. The method of claim 1, wherein outputting the power level to power the LED light system comprises:
outputting a power level to power the light system based on the brightness level.

7. The method of claim 1, wherein outputting the control data to display the at least one color and the light pattern on the LED light system comprises:
outputting the control data to display the at least one color, the light pattern, and the brightness level on the LED light system.

8. The method of claim 2, wherein the light pattern output comprises a twinkle and waves pattern output.

9. The method of claim 2, wherein the input command comprises a pattern increase speed command that increases a speed of transition of the light pattern output.

10. The method of claim 1, wherein the LED light system is an LED rope light.

11. A computing device comprising:
one or more processors;
a non-transitory computer-readable storage medium storing instructions executable by the one or more processors, wherein the one or more processors are configured to:
obtain an input command, wherein the input command comprises a light output selection;
determine at least one color to display on an LED light system based on the input command, wherein the LED light system comprises multiple LEDs connected in series;
determine a brightness level to display on the LED light system based on the input command;
determine a light pattern to display on the LED light system based on the input command;
output a power level to power the LED light system; and
output control data to display the at least one color and the light pattern on the LED light system.

12. The computing device of claim 11, wherein the one or more processors are further configured to:
determine a predefined theme based on the input command, wherein the predefined theme comprises a predefined color, predefined brightness level, and predefined light pattern to display on the LED light system; and
output the control data to display the predefined theme.

13. The computing device of claim 12, wherein the predefined theme comprises a Christmas holiday theme, wherein the Christmas holiday theme comprises a red, green, orange, purple, blue, white, warm white, and red-green-orange-purple-blue-white warm-white combination color, and light pattern output

14. The computing device of claim 12, wherein the predefined theme comprises a Halloween holiday theme, wherein the Halloween holiday theme comprises an orange, purple, green, and orange-purple-green combination color, and light pattern output.

15. The computing device of claim 12, wherein the predefined theme comprises a National Day holiday theme, wherein the National Day holiday theme comprises a blue, red, white, and blue-red-white combination color and light pattern output.

16. The computing device of claim 11, wherein the one or more processors configured to output the power level to power the light system are further configured to:
output a power level to power the LED light system based on the brightness level.

17. The computing device of claim 11, wherein the one or more processors configured to output the control data to display the at least one color and the light pattern on the LED light system are further configured to:
output the control data to display the at least one color, the light pattern, and the brightness level on the LED light system.

18. The computing device of claim 12, wherein the light pattern output comprises a twinkle and waves pattern output.

19. The computing device of claim 12, wherein the input command comprises a pattern increase speed command that increases a speed of transition of the light pattern output.

20. The computing device of claim 11, wherein the LED light system is an LED rope light.

21. A non-transitory computer-readable storage medium storing a plurality of programs for execution by a computing device having one or more processors, wherein the plurality of programs, when executed by the one or more processors, cause the computing device to perform acts comprising:
obtaining an input command, wherein the input command comprises a light output selection;
determining at least one color to display on an LED light system based on the input command, wherein the LED light system comprises multiple LEDs connected in series;
determining a brightness level to display on the LED light system based on the input command;
determining a light pattern to display on the LED light system based on the input command;
outputting a power level to power the LED light system; and
outputting control data to display the at least one color and the light pattern on the LED light system.

22. The non-transitory computer-readable storage medium of claim 21, wherein the plurality of programs further cause the computing device to perform:
determining a predefined theme based on the input command, wherein the predefined theme comprises a predefined color, predefined brightness level, and predefined light pattern to display on the LED light system; and
outputting the control data to display the predefined theme.

23. The non-transitory computer-readable storage medium of claim 21, wherein the LED light system is an LED rope light.
